(19) United States
(12) Patent Application Publication
(10) Pub. No.: US 2026/0004562 A1
(43) Pub. Date: Jan. 1, 2026

(54) SOCIETAL ATTRIBUTE NEUTRALIZER FOR DEBIASING CLIP

(71) Applicant: NVIDIA Corporation, Santa Clara, CA (US)

(72) Inventors: Ryo Hachiuma, Zhongshan District (TW); Yusuke Hirota, Suita (JP); Min-Hung Chen, Zhubei City (TW); Chien-Yi Wang, Banqiao District (TW); Yu-Chiang Wang, Neihu District (TW)

(21) Appl. No.: 19/021,140

(22) Filed: Jan. 14, 2025

Related U.S. Application Data
(60) Provisional application No. 63/665,528, filed on Jun. 28, 2024.

(51) Int. Cl. G06V 10/77; G06F 40/40; G06V 10/774; G06V 10/776

(52) U.S. Cl. CPC G06V 10/7715; G06V 10/7753; G06V 10/776; G06F 40/40

(57) ABSTRACT

The processes fine-tune vision-language models (VLMs) on large-scale image caption datasets to amend VLM text feature vectors of attribute-neutral descriptions given attribute-neutralization lists, such that the attribute-neutral descriptions are equidistant to those of attribute-specific descriptions using annotation-free debiasing loss without using attribute labels. Feature vectors for attribute-neutral descriptions can be debiased, whereas the attribute-specific descriptions retain the original information. One or more attribute groups can be used for the attribute-neutralization. There can be more than one VLM, such as for different human languages or different human cultures where some biasing can want to be retained. The processes can be applied to any image group, such as objects, animals, plants, rocks, or other object types, where there is at least one attribute group that contains at least two attributes for neutralization.

### CROSS-REFERENCE TO RELATED APPLICATION

This application claims the benefit of U.S. Provisional Application Ser. No. 63/665,528, filed on Jun. 28, 2024, entitled “SOCIETAL ATTRIBUTE NEUTRALIZER FOR DEBIASING CLIP,” commonly assigned with this application and incorporated herein by reference in its entirety.

### TECHNICAL FIELD

This application is directed, in general, to using vision-language models and, more specifically, to attribute debiasing using vision-language models.

### BACKGROUND

Societal biases, such as gender, age, or race, exist in current vision language models (VLMs), e.g., CLIP, BLIP, and other VLMs. These biases can cause VLMs to make unfair or prejudicial decisions. For example, having an input of “firefighter” can lead to a generative artificial intelligence process to output all male images. Previous solutions to this problem have been tried and have led to their own shortcomings. For example, using face-centric images with annotated societal attribute datasets to fine-tune the VLMs can be used, rather than predicting the attributes from the images. This type of solution requires attribute annotation, which requires intensive human labor. This can also limit the diversity of the training dataset to those face-centric images which can lead to an overfitting of those face-centric images. Another solution that has been tried is to remove attribute information from the input text embeddings. Even though a user may want to take specific attribute information into account, the VLM automatically eliminates the attribute information. For example, if the input requests “male firefighters”, the VLM would output male and female images.

### SUMMARY

In some aspects a method to fine-tune a vision-language model (VLM) is presented. In one embodiment, the method includes (1) receiving input parameters, wherein the input parameters include an original VLM parameter and a set of attribute groups, where the set of attribute groups contains at least one attribute group, and each the at least one attribute group contains at least two attributes, (2) receiving an image dataset parameter, wherein the image dataset parameter points to a location of an image dataset or contains the image dataset, (3) training a debiasing layer by modifying a feature space of the original VLM by processing one or more images with associated attributes in the image dataset to update text feature vectors of the one or more images using an attribute-neutralization description as specified in the at least one attribute group, wherein each attribute-neutralization description is equidistant to an attribute-specific description of the one or more images, and (4) storing a fine-tuned VLM from the original VLM parameter as modified with the debiasing layer.

In a second aspect, a method to display a set of images using a vision-language model (VLM) is disclosed. In one embodiment, the method includes (1) receiving input parameters, wherein the input parameters include a VLM parameter and a text request, where the VLM parameter is a fine-tuned VLM that is previously trained, (2) receiving an image dataset parameter, wherein the image dataset parameter points to a location of an image dataset or contains the image dataset, (3) modifying the text request using the VLM parameter, where the VLM parameter uses attribute-neutralization, (4) retrieving the set of images using the text request as modified on text feature vectors of the VLM parameter, and (5) displaying the set of images.

In a third aspect, a system is disclosed. In one embodiment, the system includes (1) a receiver, operational to receive input parameters, wherein the input parameters include a vision-language model (VLM) and a set of attribute groups, where the set of attribute groups contains at least one attribute group and each of the at least one attribute group contains at least two attributes, and (2) a VLM processor, implemented on one or more processors, and operational to generate a fine-tuned VLM by training a debiasing layer through modifying a feature space of the VLM by processing one or more images in an image dataset to update text feature vectors of the one or more images using an attribute-neutralization description as specified in the at least one attribute group, wherein each attribute-neutralization description is equidistant to an attribute-specific description of the one or more images.

In a fourth aspect, a computer program product having a series of operating instructions stored on a non-transitory computer-readable medium that directs a data processing apparatus when executed thereby to perform operations is disclosed. In one embodiment, the operations include (1) receiving input parameters, wherein the input parameters include an original VLM parameter and a set of attribute groups, where the set of attribute groups contains at least one attribute group, and each of the at least one attribute group contains at least two attributes, (2) receiving an image dataset parameter, wherein the image dataset parameter points to a location of an image dataset or contains the image dataset, (3) training a debiasing layer by modifying a feature space of the original VLM by processing one or more images in the image dataset to update text feature vectors of the one or more images using an attribute-neutralization description as specified in the at least one attribute group, wherein each attribute-neutralization description is equidistant to an attribute-specific description of the one or more images, and (4) storing a fine-tuned VLM from the original VLM parameter as modified with the debiasing layer.

### BRIEF DESCRIPTION

Reference is now made to the following descriptions taken in conjunction with the accompanying drawings, in which:

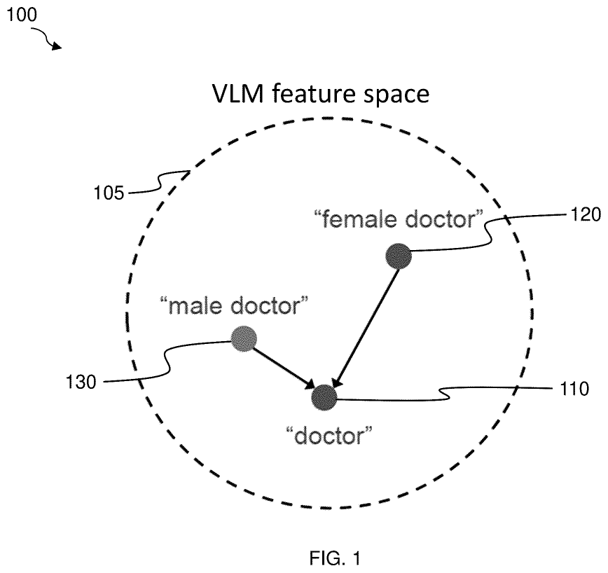

FIG. 1 is an illustration of a diagram of an example vision-language model (VLM) feature space;

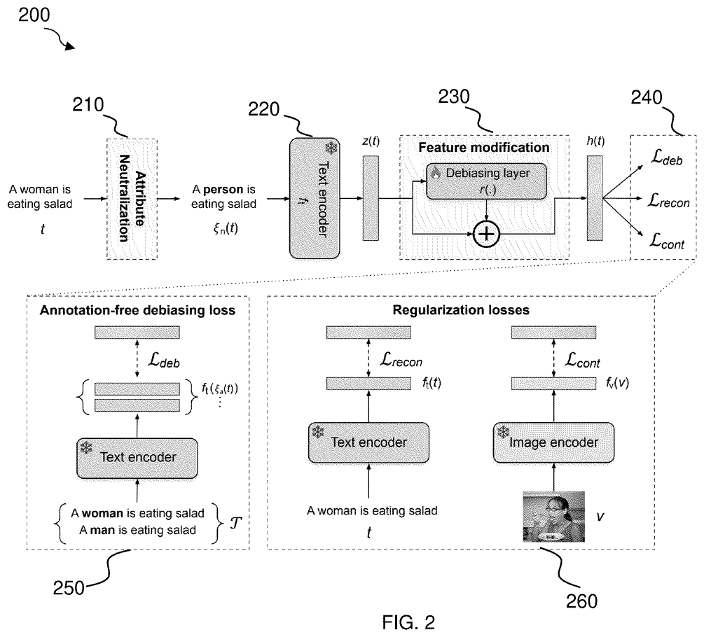

FIG. 2 is an illustration of a diagram of an example functional flow of the VLM process;

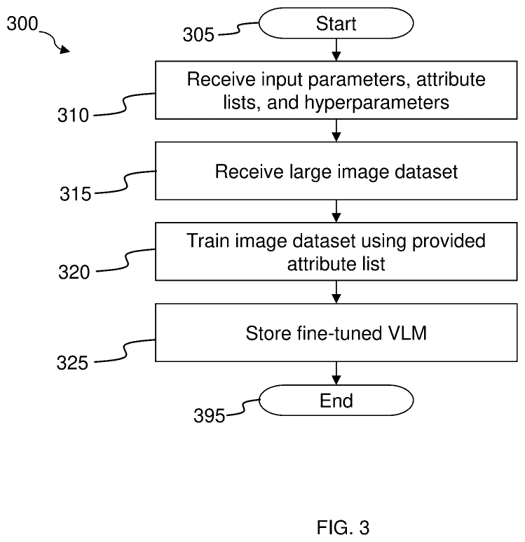

FIG. 3 is an illustration of a flow diagram of an example method to train a VLM;

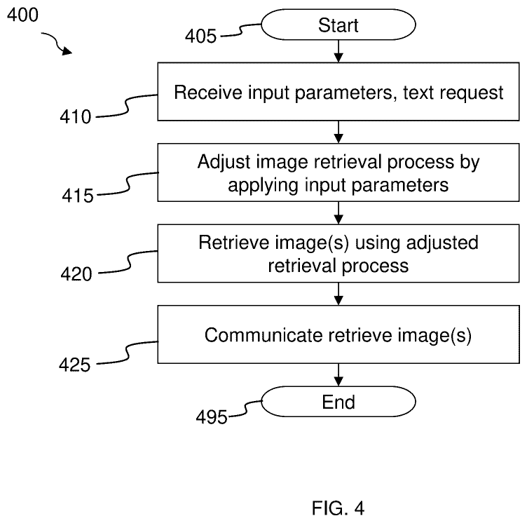

FIG. 4 is an illustration of a flow diagram of an example method to utilize a fine-tuned VLM;

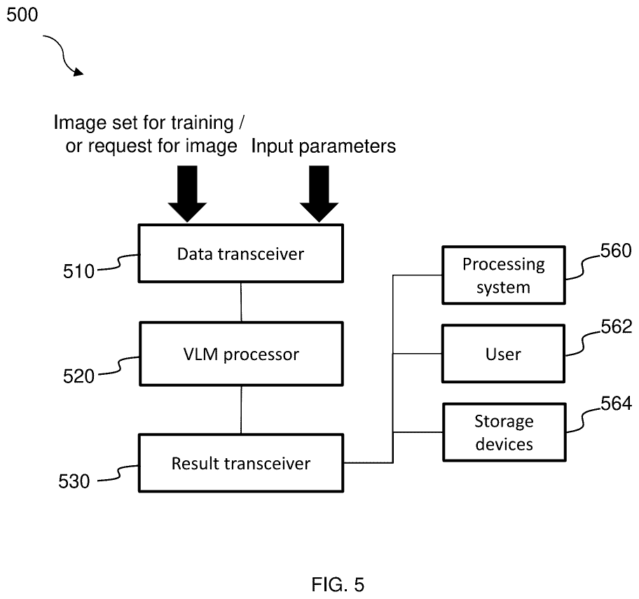

FIG. 5 is an illustration of a block diagram of an example VLM system;

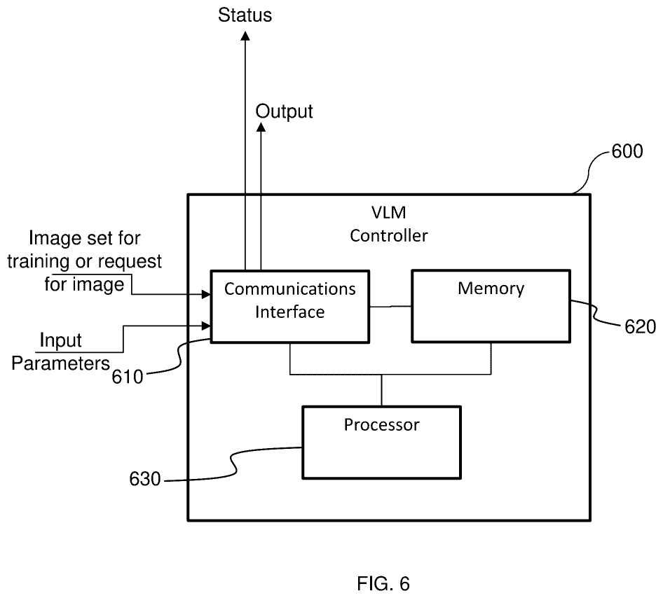

FIG. 6 is an illustration of a block diagram of an example of a VLM controller 600 according to the principles of the disclosure; and

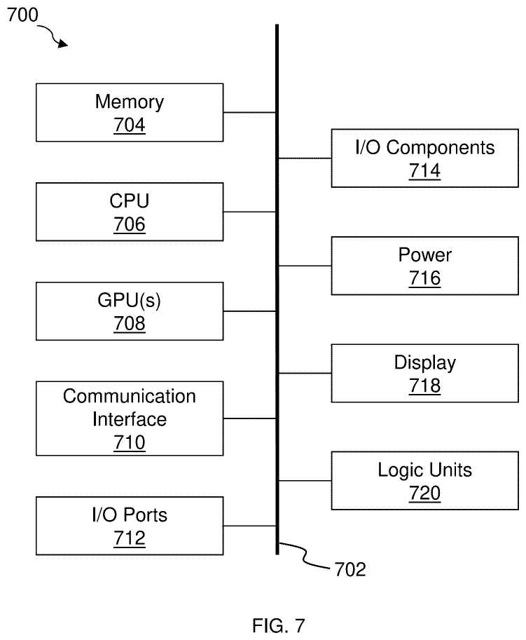

FIG. 7 illustrates a block diagram of an example of a computing device suitable for use in implementing at least a portion of some examples disclosed herein.

### DETAILED DESCRIPTION

Vision language models (VLMs) are a type of machine learning model that can generate content that combines images and text. A VLM can take in as input a text description of a person and output a series of images that fit that description. One such VLM is the contrastive language-image pre-training (CLIP) model. CLIP is an open-source tool and is used in this description as a tool to demonstrate the disclosed techniques. Another VLM is the bootstrapping language-image pre-training (BLIP) model. In some aspects, other models can be used with the disclosed techniques, such as a sigmoid loss for language-image pre-training (SigLIP) model.

Large-scale VLMs, such as CLIP, have demonstrated a remarkable capability in multi-modal understanding and generation, being trained with million-scale image-text pairs. Utilizing these VLMs, the VLMs can achieve significant performance enhancements across a wide range of computer vision tasks (e.g., image captioning and object detection), without the necessity for task-specific training. Despite the success, several works have identified societal bias regarding demographic attributes, such as gender and age, in these VLMs, potentially causing unfair or prejudicial decisions by the models. Audits on performance disparity, particularly with respect to gender, have revealed gender-dependency of the CLIP performance. Adopting CLIP for caption evaluation tends to favor gender-stereotypical sentences (e.g., preferring “A woman is cooking” over “A man is cooking” for images depicting men), highlighting the inherent gender bias. It is important to address this inherent bias in the various VLMs.

Some studies have proposed to mitigate societal bias in VLMs. Adversarial debiasing can be used to fine-tune CLIP models to lessen leakage of protected attributes into the features, while projection-based debiasing can be used to remove the protected attribute encoded in CLIP features in the inference phase. Projection-based techniques can lead to a loss of attribute data that could be useful in later requests. Adversarial-based techniques require human intervention and are subject to the human's own biases in how the revised annotations are made.

This disclosure presents a debiasing approach for VLMs, such as CLIP, called societal attribute neutralizer (SANER), that can overcome the limitations. Specifically, the disclosed processes can train a debiasing layer (i.e., a multilayer perception) to amend VLM text feature vectors of attribute-neutral descriptions, given by attribute-neutralization, such that they are equidistant to those of attribute-specific descriptions using annotation-free debiasing loss. With this, feature vectors for attribute-neutral descriptions are debiased, whereas the attribute-specific ones retain the original information. Attribute information from input texts (i.e., captions) that contain attribute words are not removed. Attribute information can be copied to attribute-neutral texts to mitigate the biases while retaining the original attribute information.

In some aspects, the disclosed processes can be a stand-alone process. In some aspects, the disclosed process can be integrated into other processes or systems. For example, the disclosed process can be integrated into artificial intelligence (AI) engines, software programs, internet search engines, or other systems.

Attribute-specific descriptions for possible attribute groups can be augmented by modifying the attribute-specific words in the original descriptions, directing the training without attribute annotations. The disclosed processes can be designed to be compatible with various datasets of image-text pairs, such as the common objects in context (COCO) large-scale datasets.

This can provide denser guidance for training the debiasing layer compared to the existing methods. Experiments on discriminative and generative tasks (i.e., text-to-image retrieval and text-to-image generation) show that the disclosed processes can mitigate gender and age biases of a VLM. The disclosed processes can outperform the existing methods, showing that the disclosed processes can lead to less attribute-dependency of the downstream performance while overcoming the limitations in existing methods.

The disclosed processes can address the limitations of the existing methods. The disclosed processes can 1) retain attribute information in cases where the person's attributes are explicitly described and 2) eliminate the reliance on attribute annotations, allowing the use of any image-text dataset for training the debiasing layer.

The disclosed processes can include 1) attribute-neutralization, which can eliminate protected attribute information from input text, 2) feature modification, which can remove attribute information from the VLM text features by amending them with a debiasing layer, 3) attribute annotation-free debiasing loss, that can help ensure the features are not biased towards any attribute group (e.g., g ∈A), and 4) regularization losses, which can preserve the original VLM features and the alignment between image and text features.

The attribute-neutralization step can be implemented by modifying the text description t E D that contains person-related words to remove attribute-specific words, thereby creating a new text caption. The attribute list can be a specified list, such as for hair color (blonde, brunette, red) or (blonde brunette, red, black, blue, pink, green). Taking binary gender as a protected attribute, e.g., A={female, male}, as an example, the text description t=“A woman is eating salad.” contains attribute information (i.e., woman). The attribute-specific terms can be replaced with the attribute-neutral ones to obtain an attribute-neutral text, such as ξₙ(t)=“A person is eating salad.” where ξₙ denotes a function for attribute-neutralization. Neutralization can be done for other attributes, such as age. Age-specific terms (e.g., young and senior) can be removed in text descriptions, for instance, “A young woman is eating salad” becomes “A woman is eating salad”. In contrast to previous approaches, which are optimized not to predict the attribute information from the original description t, the disclosed processes target the attribute-neutral descriptions ξₙ(t) to preserve the attribute information in the features of attribute-specific descriptions.

The feature modification step can be implemented to help resolve that VLM text features z(t)=fₜ(ξₙ(t)) after attribute-neutralization can still convey the protected attribute information due to the VLM's bias. To remove such bias, the disclosed processes can append a learnable debiasing layer r on top off fₜ. Neutralized t's debiased feature h(t) is given by h(t)=z(t)+r(z(t)).

Training can be employed to implement the attribute annotation-free debiasing loss. To train r to extract attribute information from VLM features without attribute annotations, the disclosed processes can generate a set T of attribute-specific descriptions for t∈D and for g∈A, e.g., T={ξ_{g}(t)|t∈D, g∈A}, where ξ_{g}(t) can generate a description specific to attribute group g from t. For the binary gender example, this can involve generating descriptions with female and male-specific words. For example, from the text description, “A woman is eating salad.”, the disclosed processes can generate two sentences with female and male attributes, “A woman is eating salad.” and “A man is eating salad.”

The debiasing loss trains r such that h(t) is equidistant from fₜ(ξ_{g}(t)) for attribute groups in A, ensuring an impartial representation across the spectrum of attribute groups, e.g., a loss calculation. This loss can be implemented as the standard deviation of the cosine similarity between h(t) and fₜ(ξg(t)). Equation 1 demonstrates this relationship where s_{g}(t) denotes the similarity.

$$\begin{matrix}Example debiasing loss relationship & \\ {s}_{g} ( t ) = \frac{{h ( t )}^{T} {f}_{t} ( {ξ}_{g} ( t ) )}{‖ h ( t ) ‖ ‖ {f}_{t} ( {ξ}_{g} ( t ) ) ‖} & Equation 1\end{matrix}$$

$$\begin{matrix}Example debiasing loss {ℒ}_{deb} & \\ {ℒ}_{deb} = \sqrt{\frac{1}{\vert D \vert} {\sum }_{t ∈ D} {( {s}_{g} ( t ) - \overline{s} ( t ) )}^{2}} & Equation 2\end{matrix}$$

where

$$\overline{s} ( t ) = {\sum }_{g ∈ A} \frac{{s}_{g} ( t )}{\vert A \vert} .$$

A lower standard deviation means s_{g} is close to s̅, leading to h(t) being equidistant to fₜ(ξ_{g}(t)) for g∈A. This debiasing loss can be computed without attribute annotations.

Applying the debiasing loss alone can significantly change the original VLM features, thereby losing semantics. To maintain the alignment of resulting image-text features, the disclosed processes can utilize reconstruction loss or contrastive loss in a regularization of losses step. Reconstruction loss [symbol] _{recon} can be the mean squared error between ft(t) and h(t). Contrastive loss [symbol] _{cont} aims to minimize the negative log-likelihood of input image-caption pairs, fᵥ(v) and fₜ(t), in comparison to negative ones. The debiasing layer can use a debiasing loss and at least one of a reconstruction loss or a contrastive loss, where the reconstruction loss is a distance vector from an original text to a debiased text or the contrastive loss is the distance vector from the image to the debiased text.

Training of the VLM can be implemented. The overall, i.e., total, loss [symbol] can be represented by Equation 3.

$$\begin{matrix}Example total loss & \\ ℒ = {αℒ}_{deb} + {βℒ}_{recon} + {γℒ}_{cont} & Equation 3\end{matrix}$$

where α, β, and γ are the hyperparameters to weight respective losses.

The hyperparameters can be user-controllable weights to control the amount of biasing that is implemented, e.g., the distance threshold. Therefore, the total loss allowed in debiasing process can be specified using the hyperparameters as input parameters. For example, α can be set to 1.0, β can be set to 0.1, and γ can be set to 0.0001. In other aspects, other values can be used for each hyperparameter. Using the reconstruction loss or contrastive loss can yield better results for bias mitigation. During inference, the trained layer r can be applied by using the modified text features r(ft(t)) as the VLM text features.

In some aspects, debiasing can occur at the image encoder. The image encoder can include a debiasing layer to remove attribute information from the visual features for images in which humans do not appear. The disclosed processes can be extended for use to other protected attributes than those specifically mentioned in this disclosure. In some aspects, combinations of attributes can be tagged for debiasing. For example, considering the intersection of binary gender and age, the disclosed processes can generate four sentences with (female, young), (female, old), (male, young), and (male, old) for the debiasing loss, e.g., “A young woman is eating salad” for the input text “A woman is eating salad”. In some aspects, the disclosed processes can be applied to various groups of objects, animals, plants, rocks, structures, or other types of items where a picture can be taken. For example, the debiasing technique can be applied to dogs. Searching for guard dogs should retrieve more images than just of German shepherds or Doberman pinchers. Searching for a tree should retrieve more than oak trees, including various other types of trees.

Turning now to the figures, FIG. 1 is an illustration of a diagram of an example VLM feature space 100. VLM feature space 100 demonstrates how some VLM models associate attribute labels. VLM feature space 100 has a feature space 105 for describing doctors. Point 110 is the attribute label for “doctor”. Point 120 is the attribute label for “female doctor”. Point 130 is the attribute label for “male doctor”. By determining attribute connections and distance to the primary attribute label, the appropriate attributes and the associated images can be retrieved.

FIG. 2 is an illustration of a diagram of an example functional flow of the VLM process 200. VLM process 200 is a functional demonstration of one implementation of the disclosed processes, e.g., an example implementation of the SANER process. The debiasing layer for feature modification can be trained over an arbitrary dataset D={(v, t)} of image v and text description t (e.g., image caption, alt text) pairs, which does provide attribute annotation a as well as target task label d. VLM process 200 uses an attribute group of gender (male, female) as applied to a person eating a salad as an example to describe how the process can operate.

VLM process 200 starts at process 210 which receives an input parameter of an original text caption or request for an image. Process 210 can perform an attribute-neutralization on the text component. This has the effect of generalizing the text component in regard to the attribute being neutralized. A second pass of attribute-neutralization can be performed as well, such as modifying the statement to “a person is eating food”, thereby neutralizing the attribute salad. Additional passes of attribute-neutralization can be performed until each applicable attribute group that is specified in the VLM has been reviewed or checked.

In a step 220, a text encoder can be applied to the input parameter text. The text encoder can prepare the input parameter for a feature modification step to help resolve that VLM text features z(t)=ft(ξn(t)) after attribute-neutralization can still convey the protected attribute information due to the VLM's bias. To remove such bias, the disclosed processes can append a learnable debiasing layer r on top of fₜ. Neutralized t's debiased feature h(t) is given by h(t)=z(t)+r(z(t)). In a process 230 the feature modification step is applied as a debiasing layer. This can remove attribute information from the VLM text features by amending them with the debiasing layer.

In a process 240, the debiasing loss can be calculated as shown in Equation 2 and Equation 3. The total loss is the combination of the debiasing loss, the reconstruction loss, and the contrastive loss. The losses are shown in further detail in a process 250 and a process 260. In process 250, the annotation-free debiasing loss is demonstrated. In process 260, the reconstruction loss and the contrastive loss are demonstrated.

FIG. 3 is an illustration of a flow diagram of an example method 300 to train a VLM. Method 300 can be performed on a computing system, for example, VLM system 500 of FIG. 5 or VLM controller 600 of FIG. 6. The computing system can be one or more processors in various combinations (e.g., CPUs, GPUs, SIMDs, or other types of processors), a data center, a cloud environment, a server, a laptop, a mobile device, a smartphone, a PDA, or other computing system capable of receiving the thread requests, and capable of executing threads in parallel. Method 300 can be encapsulated in software code or hardware, for example, an application, code library, code module, dynamic link library, module, function, RAM, ROM module, and other software and hardware implementations. The software can be stored in a file, database, or other computing system storage mechanism. Method 300 can be partially implemented in software and partially in hardware. Method 300 can perform the steps for the described processes, for example, identifying a thermal interface layer that has failed within a chip or board package and directing or sorting the chip or board package according to the thermal failure state.

Method 300 starts at a step 305 and proceeds to a step 310. In step 310 input parameters can be received. The input parameters can include one or more attribute groups, where each attribute group comprises at least two attributes. For example, an attribute group of genders or an attribute group of lawyers. In some aspects, at least one attribute group relates to one or more of a societal attribute, an animal attribute, or a plant attribute. In some aspects, one or more hyperparameters can be received. Each hyperparameter can be a weighting factor applied to one of the loss types, e.g., the debiasing loss, the reconstruction loss, or the contrastive loss. Other input parameters can be received to control the training of the VLM, such as selecting which VLM to train.

In a step 315, an image dataset can be received or a location of an image dataset can be received, such as using an image dataset parameter to point to a location of an image dataset or that contains the image dataset. The process can reach out to the location of the image dataset and process the image. An image dataset can be an image with a caption, an image with text, an image with metadata, or other combinations of images and corresponding data. In a step 320, the image dataset can be used to train the VLM using one or more attribute groups. The images in the image dataset can be fined-tuned with text attribute information from the attribute groups in a feature space, for example, feature space 105 of FIG. 1. This enables the training of the debiasing layer by modifying a feature space of the original VLM by processing each image with its associated attributes in the image dataset to update text feature vectors of each image using an attribute-neutralization description as specified in the attribute group (of which there is at least one attribute group, and there can be more than one attribute group), wherein each attribute-neutralization description is equidistant to an attribute-specific description of each image, thereby generating an equidistant parameter.

In a step 325, the fine-tuned VLM can be stored, such as in a VLM data store. The fine-tuned VLM can be used to process an image request using the fine-tuned set of feature space attributes. Method 300 ends at a step 395.

FIG. 4 is an illustration of a flow diagram of an example method 400 to utilize a fine-tuned VLM. Method 400 can be performed on a computing system, for example, VLM system 500 of FIG. 5 or VLM controller 600 of FIG. 6. The computing system can be one or more processors in various combinations (e.g., CPUs, GPUs, SIMDs, or other types of processors), a data center, a cloud environment, a server, a laptop, a mobile device, a smartphone, a PDA, or other computing system capable of receiving the thread requests, and capable of executing threads in parallel. Method 400 can be encapsulated in software code or in hardware, for example, an application, code library, code module, dynamic link library, module, function, RAM, ROM module, and other software and hardware implementations. The software can be stored in a file, database, or other computing system storage mechanism. Method 400 can be partially implemented in software and partially in hardware. Method 400 can perform the steps for the described processes, for example, identifying a thermal interface layer that has failed within a chip or board package and directing or sorting the chip or board package according to the thermal failure state.

Method 400 starts at a step 405 and proceeds to a step 410. In step 410, input parameters can be received. Input parameters can include text requests, for example, a text caption, text portion, textual context, or other text item parameters. In some aspects, a VLM selection can be included, such as an original VLM parameter. For example, VLMs can be fine-tuned using a specific language, where a separate VLM can be used for different human languages. In another example, a VLM can be fine-tuned to certain types of attribute groups or can be fine-tuned to specific types of human cultures. For example, certain cultural biases can be maintained when someone from that specific culture is conducting a text request while someone from another culture can want to avoid those cultural biases.

In a step 415, the image retrieval process can be adjusted using the input parameters. The search criteria can be adjusted so that appropriate images for the type of request will be returned. In a step 420, the images can be retrieved that match the adjusted image retrieval process. In a step 425, the retrieved images can be communicated. In some aspects, the retrieved images can be communicated to a user. In some aspects, the retrieved images can be communicated to a system or process. For example, the images can be communicated to a security system, an AI system, an application, a game, or other types of systems or processes, whether located proximate to where the VLM process is executing or located distant from where the VLM process is executing. Method 400 ends at a step 495.

FIG. 5 is an illustration of a block diagram of an example VLM system 500. VLM system 500 can be implemented in one or more computing systems or one or more processors. In some aspects, VLM system 500 can be implemented using a VLM controller such as VLM controller 600 of FIG. 6. VLM system 500 can implement one or more aspects of this disclosure, such as method 300 of FIG. 3 or method 400 of FIG. 4.

VLM system 500, or a portion thereof, can be implemented as an application, a code library, a dynamic link library, a function, a module, a header file, other software implementations, or combinations thereof. In some aspects, VLM system 500 can be implemented in hardware, such as a ROM, a graphics processing unit, or other hardware implementation. In some aspects, VLM system 500 can be implemented partially as a software application and partially as a hardware implementation. VLM system 500 is a functional view of the disclosed processes and an implementation can combine or separate the described functions in one or more software or hardware systems.

VLM system 500 includes a data transceiver 510, a VLM processor 520, and a result transceiver 530. The output, e.g., the fine-tuned VLM when training is performed or a set of images when a text request is received, can be communicated to a data receiver, such as one or more of a processing system 560 (one or more combinations of processors or processing cores), one or more users 562, or one or more storage devices 564. The output can be used to store a fine-tuned VLM after training or to provide a set of images for further use.

In some aspects, the results of the VLM processor, such as those communicated to one or more processing systems 560, one or more storage devices 564, or one or more users 562, can be used as input into another process or system. The set of images can be used for further processing, such as for education in a classroom, security screening, or other applications.

Data transceiver 510 can receive the input parameters, as well as operational parameters such as a VLM to use, a text request, an image dataset, weighting values for hyperparameters, and other operational parameters, where the input parameters vary whether training is being performed or a text request is being processed. In some aspects, data transceiver 510 can be part of VLM processor 520.

Result transceiver 530 can communicate one or more outputs, to one or more data receivers, such as processing systems 560, one or more users 562, storage devices 564, or other related systems, whether proximate result transceiver 530 or distant from result transceiver 530. Data transceiver 510, VLM processor 520, and result transceiver 530 can be, or can include, conventional interfaces configured for transmitting and receiving data. Data transceiver 510, VLM processor 520, or result transceiver 530 can be implemented as software components, for example, a virtual processor environment, as hardware, for example, circuits of an integrated circuit, or combinations of software and hardware components and functionality. The functionality described for these components remains intact regardless of how the functionality is implemented.

VLM processor 520 (e.g., one or more processors such as processor 630 of FIG. 6) can implement the analysis and algorithms as described herein utilizing the input parameters, VLMs, and image datasets. VLM processor 520 can be one or more of a multicore processor, a multiprocessor system, or a streaming multiprocessor. VLM processor 520 can be implemented by a central processing unit (CPU), a graphics processing unit (GPU), or other types of processors.

A memory or data storage system of VLM processor 520 (such as a core cache, L1 cache, L2 cache, or other memory systems) can be configured to store the processes and algorithms for directing the operation of VLM processor 520. VLM processor 520 can include a processor that is configured to operate according to the analysis operations and algorithms disclosed herein, and an interface to communicate (transmit and receive) data.

FIG. 6 is an illustration of a block diagram of an example of a VLM controller 600 according to the principles of the disclosure. VLM controller 600 can be stored on one computer or multiple computers. The various components of VLM controller 600 can communicate via wireless or wired conventional connections. A portion or a whole of VLM controller 600 can be located at one or more locations. In some aspects, VLM controller 600 can be part of another system (e.g., processor, core, server, or other systems), and can be integrated with one device, such as a part of a processing system. VLM controller 600 represents a demonstration of the functionality employed for the disclosure, and implementations can use a variety of devices, for example, circuits of a processor, dedicated processors, virtual systems, servers, other computing or processing systems, be in software or hardware, or various combinations thereof.

VLM controller 600 can be configured to perform the various functions disclosed herein including receiving input parameters and generating results from the execution of the methods and processes described herein, such as training a VLM to be a fine-tuned VLM or returning a set of images. VLM controller 600 includes a communications interface 610, a memory 620, and a processor 630.

Communications interface 610 is configured to transmit and receive data. For example, communications interface 610 can receive the input parameters, VLMs, and image datasets. Communications interface 610 can transmit the output or interim outputs. In some aspects, communications interface 610 can transmit a status, such as a success or failure indicator of VLM controller 600 regarding receiving the various inputs, transmitting the generated outputs, or producing the results.

In some aspects, processor 630 can perform the operations as described by VLM processor 520. Communications interface 610 can communicate via communication systems used in the industry. For example, wireless or wired protocols can be used. Communication interface 610 can perform the operations as described for data transceiver 510 and result transceiver 530 of FIG. 5.

Memory 620 can be configured to store a series of operating instructions that direct the operation of processor 630 when initiated, including supporting code representing the algorithm for training a VLM to be a fine-tuned VLM or retrieving an appropriate image set. Memory 620 is a non-transitory computer-readable medium. Multiple types of memory can be used for the data storage systems and memory 620 can be distributed.

Processor 630 can be one or more processors. Processor 630 can be a combination of processor types, such as a CPU, a GPU, a single instruction multiple data (SIMD) processor, or other processor types. Processor 630 can be configured to produce the output, one or more interim outputs, and statuses utilizing the received inputs. Processor 630 can determine the output using parallel processing. Processor 630 can be an integrated circuit. In some aspects, processor 630, communications interface 610, memory 620, or various combinations thereof, can be an integrated circuit. Processor 630 can be configured to direct the operation of VLM controller 600. Processor 630 includes the logic to communicate with communications interface 610 and memory 620, and perform the functions described herein. Processor 630 is capable of performing or directing the operations as described by VLM processor 520 of FIG. 5.

For example, in some aspects, VLM system 500 or VLM controller 600 can perform an image retrieval function and can be part of a system, process, or application, or can be accessed remotely, such as a code library, remote function, or remote process. In some aspects, VLM system 500 or VLM controller 600 can be part of another system that receives. For example, in some aspects, VLM system 500 or VLM controller 600 can be part of a security system, an AI generative tool, or can be in a data center, a cloud system, an edge system, a corporate system, or other type of system or location. In some aspects, the image datasets and the VLMs can be received from a data store, such as a database or a server. In some aspects, VLM system 500 or VLM controller 600 can be part of a machine learning system, where the VLM is part of the machine learning processes. In some aspects, VLM system 500 or VLM controller 600 can implement a computer program product having a series of operating instructions stored on a non-transitory computer-readable medium that directs a data processing apparatus when executed thereby to perform operations, the operations comprising the steps described herein for this disclosure, such as method 400 of FIG. 4.

FIG. 7 illustrates a block diagram of an example of a computing device 700 suitable for use in implementing at least a portion of some examples disclosed herein. Computing device 700 can include an interconnect system 702 that directly or indirectly couples the following devices: memory 704, one or more CPUs 706, one or more GPUs 708, a communication interface 710, input/output (I/O) ports 712, input/output components 714, a power supply 716, one or more display 718, and one or more logic units 720.

Although the various blocks of FIG. 7 are shown as connected via the interconnect system 702 with lines, this is not intended to be limiting and is presented for clarity. For example, in some embodiments, display 718, or another presentation component, can be considered an I/O component 714 (e.g., if the display 718 is a touch screen). As another example, the CPUs 706 or GPUs 708 can include memory (e.g., the memory 704 can be representative of a storage device in addition to the memory of the GPUs 708, the CPUs 706, or other components). In other words, the computing device 700 of FIG. 7 is merely illustrative. A distinction is not made between such categories as workstation, server, laptop, desktop, tablet, client device, mobile device, hand-held device, game console, electronic control unit (ECU), virtual reality system, or other device or system types, as contemplated within the scope of the computing device 700 of FIG. 7. The computing device 700, or at least portions thereof, can correspond to one or more of the computing devices disclosed herein, such as associated with FIG. 5 and FIG. 6.

The interconnect system 702 can represent one or more links or buses, such as an address bus, a data bus, a control bus, or a combination thereof. The interconnect system 702 can include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, or another type of bus or link. There can be direct connections between components. As an example, the CPU 706 can be directly connected to the memory 704. Further, the CPU 706 can be directly connected to the GPU 708. Where there is a direct, or point-to-point connection between components, the interconnect system 702 can include a PCIe link to carry out the connection. In these examples, a PCI bus need not be included in the computing device 700.

The memory 704 can include any of a variety of computer-readable media. The computer-readable media can be any available media that can be accessed by the computing device 700. The computer-readable media can include volatile and nonvolatile media, and removable and non-removable media. By way of example, and not limitation, computer-readable media can comprise computer storage media and communication media.

The computer-storage media can include volatile and nonvolatile media or removable and non-removable media implemented in any method or technology for storage of information such as computer-readable instructions, data structures, program modules, or other data types. For example, the memory 704 can store computer-readable instructions (e.g., that represent a computer program(s) or a program element(s)), such as an operating system and computer programs disclosed herein. Computer-storage media can include but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 700. As used herein, computer storage media does not comprise signals per se.

The computer storage media can embody computer-readable instructions, data structures, program modules, or other data types in a modulated data signal such as a carrier wave or other transport mechanism and includes any information delivery media. The term “modulated data signal” can refer to a signal that has one or more of its characteristics set or changed in such a manner as to encode information in the signal. By way of example, and not limitation, the computer storage media can include wired media such as a wired network or direct-wired connection, and wireless media such as acoustic, RF, infrared, and other wireless media. Combinations of any of the above should also be included within the scope of computer-readable media.

The CPU(s) 706 can be configured to execute at least some of the computer-readable instructions to control one or more components of the computing device 700 to perform one or more of the methods or processes described herein. The CPU(s) 706 can each include one or more cores (e.g., one, two, four, eight, twenty-eight, seventy-two, or other) that are capable of handling a multitude of software threads simultaneously. The CPU(s) 706 can include any type of processor and can include different types of processors depending on the type of computing device 700 implemented (e.g., processors with fewer cores for mobile devices and processors with more cores for servers). For example, depending on the type of computing device 700, the processor can be an Advanced RISC Machines (ARM) processor implemented using Reduced Instruction Set Computing (RISC) or an x86 processor implemented using Complex Instruction Set Computing (CISC). The computing device 700 can include one or more CPUs 706 in addition to one or more microprocessors or supplementary co-processors, such as math co-processors.

In addition to or alternatively, from the CPU(s) 706, the GPU(s) 708 can be configured to execute at least some of the computer-readable instructions to control one or more components of the computing device 700 to perform one or more of the methods or processes described herein. One or more of the GPU(s) 708 can be an integrated GPU (e.g., with one or more of the CPU(s) 706 or one or more of the GPU(s) 708 can be a discrete GPU. One or more of the GPU(s) 708 can be a coprocessor of one or more of the CPU(s) 706. The GPU(s) 708 can be used by the computing device 700 to render graphics (e.g., 3D graphics) or perform general-purpose computations. For example, the GPU(s) 708 can be used for General-Purpose computing on GPUs (GPGPU). The GPU(s) 708 can include hundreds or thousands of cores that are capable of handling hundreds or thousands of software threads simultaneously. The GPU(s) 708 can perform operations as disclosed herein or generate pixel data for output images in response to rendering commands (e.g., rendering commands from the CPU(s) 706 received via a host interface).

The GPU(s) 708 can include graphics memory, such as display memory, for storing pixel data or any other suitable data, such as GPGPU data. The display memory can be included as part of the memory 704. The GPU(s) 708 can include two or more GPUs operating in parallel (e.g., via a link), which includes substantially in parallel. The link can directly connect the GPUs (e.g., using NVLINK) or can connect the GPUs through a switch (e.g., using NVSwitch). When combined, each GPU 708 can generate pixel data or GPGPU data for different portions of an output or for different outputs (e.g., a first GPU for a first image and a second GPU for a second image). Each GPU can include its own memory or can share memory with other GPUs.

In addition to, or alternatively, from the CPU(s) 706 or the GPU(s) 708, the logic unit(s) 720 can be configured to execute at least some of the computer-readable instructions to control one or more components of the computing device 700 to perform one or more of the methods or processes described herein. In embodiments, the CPU(s) 706, the GPU(s) 708, or the logic unit(s) 720 can discretely or jointly perform any combination of the methods, processes, or portions thereof. One or more of the logic units 720 can be part of or integrated in one or more of the CPU(s) 706 or the GPU(s) 708 or one or more of the logic units 720 can be discrete components or otherwise external to the CPU(s) 706 or the GPU(s) 708. In embodiments, one or more of the logic units 720 can be a coprocessor of one or more of the CPU(s) 706 or one or more of the GPU(s) 708.

Examples of the logic unit(s) 720 include one or more processing cores or components thereof, such as Tensor Cores (TCs), Tensor Processing Units(TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, or other types of processors or processor components.

The communication interface 710 can include one or more receivers, transmitters, or transceivers that enable the computing device 700 to communicate with other computing devices via an electronic communication network, including wired or wireless communications. The communication interface 710 can include components and functionality to enable communication over any of a number of different networks, such as wireless networks (e.g., Wi-Fi, Z-Wave, Bluetooth, Bluetooth LE, ZigBee, or other), wired networks (e.g., communicating over Ethernet or InfiniBand), low-power wide-area networks (e.g., LoRaWAN, SigFox, or other), or the Internet.

The I/O ports 712 can enable the computing device 700 to be logically coupled to other devices including the I/O components 714, the display 718, or other components, some of which can be built into (e.g., integrated in) the computing device 700. Illustrative I/O components 714 include a microphone, mouse, keyboard, joystick, game pad, game controller, satellite dish, scanner, printer, wireless device, or other. One of the I/O components 714 can be an input device, that provides actual motion data. The I/O components 714 can provide a natural user interface (NUI) that processes air gestures, voice, or other physiological inputs generated by a user. In some instances, inputs can be transmitted to an appropriate network element for further processing. An NUI can implement any combination of speech recognition, stylus recognition, facial recognition, biometric recognition, gesture recognition on screen and adjacent to the screen, air gestures, head and eye tracking, and touch recognition (as described in more detail below) associated with a display of the computing device 700. The computing device 700 can include depth cameras, such as stereoscopic camera systems, infrared camera systems, RGB camera systems, touchscreen technology, and combinations of these, for gesture detection and recognition. Additionally, the computing device 700 can include accelerometers or gyroscopes (e.g., as part of an inertia measurement unit (IMU)) that enable detection of motion. In some examples, the output of the accelerometers or gyroscopes can be used by the computing device 700 to render immersive augmented reality or virtual reality.

The power supply 716 can include a hard-wired power supply, a battery power supply, or a combination thereof. The power supply 716 can provide power to the computing device 700 to enable the components of the computing device 700 to operate. The display 718 can be a monitor, a touch screen, a television screen, a HUD, other display types, or a combination thereof, and include audio presentation components such as speakers. The display 718 can receive data from other components (e.g., the GPU(s) 708, the CPU(s) 706), and output the data (e.g., as an image, video, sound). Instead of display 718, a monitor can be used as an I/O component to display an interactive program. As such, a monitor can include the logic for processing and comparing actual and inferred motion data and generating a cheating alert. The monitor can be connected to the computing device 700 via an HDMI connection/cable, which can include an auxiliary connection.

A portion of the above-described apparatus, systems, or methods can be embodied in or performed by various digital data processors or computers, wherein the computers are programmed or store executable programs of sequences of software instructions to perform one or more of the steps of the methods. The software instructions of such programs can represent algorithms and be encoded in machine-executable form on non-transitory digital data storage media, e.g., magnetic or optical disks, random-access memory (RAM), magnetic hard disks, flash memories, or read-only memory (ROM), to enable various types of digital data processors or computers to perform one, multiple or all of the steps of one or more of the above-described methods, or functions, systems or apparatuses described herein. The data storage media can be part of or associated with digital data processors or computers.

The digital data processors or computers can be comprised of one or more GPUs, one or more CPUs, one or more of other processor types, or a combination thereof. The digital data processors and computers can be located proximate to each other, proximate to a user, in a cloud environment, a data center, or located in a combination thereof. For example, some components can be located proximate to the user, and some components can be located in a cloud environment or data center.

The GPUs can be embodied on one semiconductor substrate, included in a system with one or more other devices such as additional GPUs, a memory, and a CPU. The GPUs can be included on a graphics card that includes one or more memory devices and is configured to interface with the motherboard of a computer. The GPUs can be integrated GPUs (iGPUs) that are co-located with a CPU on one chip. Configured or configured to means, for example, designed, constructed, or programmed, with the necessary logic or features for performing a task or tasks.

Portions of disclosed examples or embodiments can relate to computer storage products with a non-transitory computer-readable medium that have program code thereon for performing various computer-implemented operations that embody a part of an apparatus, device or carry out the steps of a method set forth herein. Non-transitory used herein refers to all computer-readable media except for transitory, propagating signals. Examples of non-transitory computer-readable media include but are not limited to: magnetic media such as hard disks, floppy disks, and magnetic tape; optical media such as CD-ROM disks; magneto-optical media such as floppy disks; and hardware devices that are specially configured to store and execute program code, such as ROM and RAM devices. Configured or configured to means, for example, designed, constructed, or programmed, with the necessary logic or features for performing a task or tasks. Examples of program code include machine code, such as produced by a compiler, and files containing higher-level code that can be executed by the computer using an interpreter.

In interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps can be present, or utilized, or combined with other elements, components, or steps that are not expressly referenced.

Those skilled in the art to which this application relates will appreciate that other and further additions, deletions, substitutions, and modifications can be made to the described embodiments. It is also to be understood that the terminology used herein is for the purpose of describing particular embodiments only, and is not intended to be limiting, since the scope of the present disclosure will be limited only by the claims. Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, a limited number of the exemplary methods and materials are described herein.

One or more of the below example independent claims can have one or more of the features of the example dependent claims in combination.

What is claimed is:

1. A method to fine-tune a vision-language model (VLM), comprising:
receiving input parameters, wherein the input parameters include an original VLM parameter and a set of attribute groups, where the set of attribute groups contains at least one attribute group, and each the at least one attribute group contains at least two attributes;
receiving an image dataset parameter, wherein the image dataset parameter points to a location of an image dataset or contains the image dataset;
training a debiasing layer by modifying a feature space of the original VLM by processing one or more images with associated attributes in the image dataset to update text feature vectors of the one or more of the images using an attribute-neutralization description as specified in the at least one attribute group, wherein each attribute-neutralization description is equidistant to an attribute-specific description of the one or more images; and
storing a fine-tuned VLM from the original VLM parameter as modified with the debiasing layer.

2. The method as recited in claim 1, wherein the debiasing layer uses a debiasing loss and at least one of a reconstruction loss or a contrastive loss, where the reconstruction loss is a distance vector from an original text to a debiased text or the contrastive loss is the distance vector from the one or more images to the debiased text.

3. The method as recited in claim 1, wherein the input parameters include at least one hyperparameter, wherein the at least one hyperparameter are used as weighting values for loss calculations.

4. The method as recited in claim 3, wherein the at least one hyperparameter are applied to the loss calculations to determine an equidistant parameter to the attribute-specific description for the each attribute-neutralization description.

5. The method as recited in claim 1, wherein the modifying the feature space augments the attribute-specific description for the set of attribute groups by modifying attribute-specific words of an original description.

6. The method as recited in claim 1, wherein the training the debiasing layer is annotation-free.

7. The method as recited in claim 1, wherein the debiasing layer utilizes an attribute-neutralization, where protected attribute information is eliminated from an original text caption of the one or more images in the image dataset and a new text caption is stored in the feature space.

8. The method as recited in claim 7, wherein the debiasing layer utilizes a feature modification that modifies the text feature vectors to reduce an incidence of the original text caption being used compared to the new text caption.

9. The method as recited in claim 1, wherein the VLM is a contrastive language-image pre-training (CLIP) model or a bootstrapping language-image pre-training (BLIP) model.

10. The method as recited in claim 1, wherein the VLM is a sigmoid loss for language-image pre-training (SigLIP) model.

11. The method as recited in claim 1, wherein the modifying the feature space utilizes more than one attribute group in the at least one attribute group, and the debiasing layer utilizes a combination of attributes across the more than one attribute group.

12. The method as recited in claim 1, wherein the at least one attribute group relates to a societal attribute, an animal attribute, or a plant attribute.

13. The method as recited in claim 1, wherein the original VLM parameter is more than one VLM parameter, and each VLM parameter in the more than one VLM parameter relate to a different human language or a different human culture.

14. A method to display a set of images using a vision-language model (VLM), comprising:
receiving input parameters, wherein the input parameters include a VLM parameter and a text request, where the VLM parameter is a fine-tuned VLM that is previously trained;
receiving an image dataset parameter, wherein the image dataset parameter points to a location of an image dataset or contains the image dataset;
modifying the text request using the VLM parameter, where the VLM parameter uses attribute-neutralization;
retrieving the set of images using the text request as modified on text feature vectors of the VLM parameter; and
displaying the set of images.

15. The method as recited in claim 14, wherein the attribute-neutralization eliminates protected attribute information from the text request.

16. A system, comprising:
a receiver, operational to receive input parameters, wherein the input parameters include a vision-language model (VLM) and a set of attribute groups, where the set of attribute groups contains at least one attribute group and each of the at least one attribute group contains at least two attributes; and
a VLM processor, implemented on one or more processors, and operational to generate a fine-tuned VLM by training a debiasing layer through modifying a feature space of the VLM by processing one or more images in an image dataset to update text feature vectors of the one or more images using an attribute-neutralization description as specified in the at least one attribute group, wherein each attribute-neutralization description is equidistant to an attribute-specific description of the one or more images.

17. The system as recited in claim 16, wherein the image dataset is located in a data store and the VLM processor accesses the data store.

18. The system as recited in claim 16, further comprising:
a transmitter, operational to communicate the fine-tuned VLM to a VLM data store.

19. The system as recited in claim 16, wherein the VLM processor can utilize the fine-tuned VLM to retrieve a set of images from the image dataset using a received text request.

20. The system as recited in claim 16, wherein the system is part of a separate image system.

21. The system as recited in claim 16, wherein the training the debiasing layer includes receiving hyperparameters that are used to weight a loss, where the loss is used to modify the text feature vectors between an original text caption and the attribute-neutralization description.

22. The system as recited in claim 21, wherein the loss is one or more of a debiasing loss, a reconstruction loss, or a contrastive loss.

23. A computer program product having a series of operating instructions stored on a non-transitory computer-readable medium that directs a data processing apparatus when executed thereby to perform operations, the operations comprising:
receiving input parameters, wherein the input parameters include an original VLM parameter and a set of attribute groups, where the set of attribute groups contains at least one attribute group, and each of the at least one attribute group contains at least two attributes;
receiving an image dataset parameter, wherein the image dataset parameter points to a location of an image dataset or contains the image dataset;
training a debiasing layer by modifying a feature space of the original VLM by processing one or more images in the image dataset to update text feature vectors of the one or more images using an attribute-neutralization description as specified in the at least one attribute group, wherein each attribute-neutralization description is equidistant to an attribute-specific description of the one or more images; and
storing a fine-tuned VLM from the original VLM parameter as modified with the debiasing layer.

24. The computer program product recited in claim 23, wherein the debiasing layer uses at least one of a debiasing loss, a reconstruction loss, or a contrastive loss, where the reconstruction loss is a distance vector from an original text to a debiased text and the contrastive loss is the distance vector from the one or more images to the debiased text.
